(19) United States
(12) Patent Application Publication
(10) Pub. No.: US 2011/0241545 A1
(43) Pub. Date: Oct. 6, 2011

(54) VEHICLE HEADLIGHT ALERT SYSTEM AND METHOD

(75) Inventors: Thomas Lee Miller, Ann Arbor, MI (US); Scott Alan Watkins, Sterling Heights, MI (US); Ronald Patrick Brombach, Plymouth, MI (US); Douglas George Rosner, Livonia, MI (US); David Gordon VanAmberg, Livonia, MI (US)

(73) Assignee: FORD GLOBAL TECHNOLOGIES, LLC, Dearborn, MI (US)

(21) Appl. No.: 12/750,169

(22) Filed: Mar. 30, 2010

(51) Int. Cl. B60Q 1/02

(52) U.S. Cl. 315/82

(57) ABSTRACT

A vehicle controller may be configured to detect a headlight condition wherein a headlight is off and an ambient light level is less than a predetermined threshold, and to reduce electrical power supplied to an electrically powered vehicle interior accessory device in response to detecting the headlight condition to inform a driver that the headlight is off.

### BACKGROUND

The look and feel of a vehicle's interior may make a lasting impression that can either strongly encourage or discourage a customer from purchasing the vehicle. As a result, vehicle interior designers, in certain circumstances, are using technologies such as highly efficient multicolored light emitting diodes (LEDs) for vehicle interior ambient lighting.

In the past, gauges on the instrument panel were typically illuminated only at night when the headlights were turned on, which minimized power consumption and maximized bulb life. Therefore, these gauges were designed to allow natural light to illuminate them during the daytime. Technologies such as LEDs may provide designers with additional freedom to introduce more depth in the vehicle's interior. LED ambient lighting, for example, may allow designers to illuminate instrument cluster gauges independent of daylight—with little impact on cost, power consumption and bulb life. Therefore, designers may now be able to increase gauge depth to enhance interior design and improve the customer experience.

### SUMMARY

A driver of a vehicle may be informed that a headlight is off by, for example, determining whether the headlight is off, determining whether an ambient light level is less than a predetermined threshold, and causing, by a controller, an intensity of an instrument cluster illumination source to be reduced if the headlight is off and the ambient light level is less than the predetermined threshold.

### BRIEF DESCRIPTION OF THE DRAWINGS

FIG. 1 is a block diagram illustrating example inputs to and outputs from an embodiment of a control algorithm for an instrument panel's illumination source.

FIG. 2 is a block diagram of an embodiment of an automotive vehicle.

FIG. 3 is an example state transition diagram associated with an embodiment of a control algorithm for an instrument panel's illumination source.

FIG. 4 is an example plot of sun load versus illumination source intensity.

### DETAILED DESCRIPTION

Lighting used to illuminate otherwise dark instrument panel gauges is commonly referred to as day backlighting. Although day backlighting may be an enhancement to vehicle interior design, it may also present certain issues. Traditionally as daytime transitioned to nighttime, the instrument panel would become difficult to see. This would serve as an indicator to the customer that it was time to turn on the headlights. Likewise, when a customer began a drive cycle in the evening hours, a dark instrument panel would serve as a reminder to turn on the headlights. With day backlighting, the instrument panel is illuminated during both the daytime and nighttime hours. As a result, a dark instrument panel may no longer serve as a reminder to turn on the headlights.

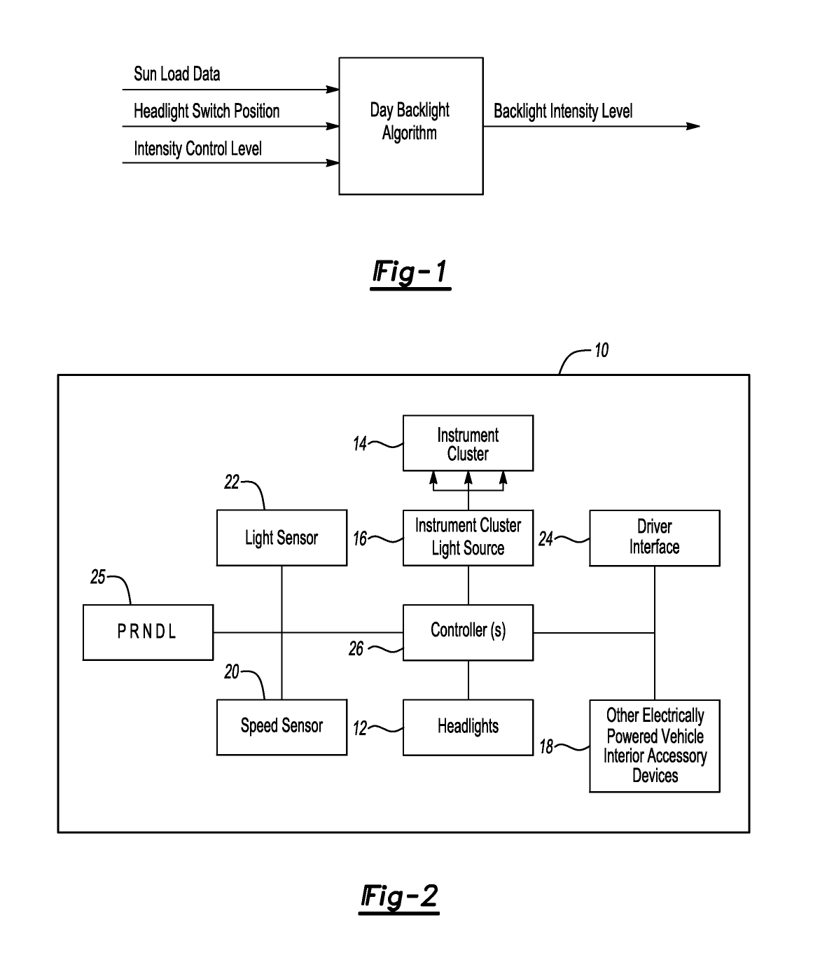

Referring to FIG. 1, an embodiment of a vehicle instrument panel lighting control algorithm may take as input sun load data, headlight switch position data and headlight intensity control level data. Other inputs such as vehicle speed, gear PRNDL position, engine RPM, etc., however, may also be used. The control algorithm may determine the backlight intensity level for the instrument panel based on one or more of these inputs such that, for example, the lighting intensity for the instrument panel may be decreased if the headlight switch position is off and the sun load is low.

Similar algorithms may be used to control other electrically powered vehicle devices such as a navigation system display, a radio system display, a climate system display, other interior lighting (e.g., dome light, lights for switches, etc.), an electrically powered air conditioning system fan, etc. By ramping down the power to or turning off these components, a driver of the vehicle may be reminded to turn on the headlights.

Referring to FIG. 2, an embodiment of an automotive vehicle 10 includes a pair of headlights 12, an instrument cluster 14, an instrument cluster light source 16 (such as LEDs, etc.) and other electrically powered vehicle interior accessory devices 18 (such as a radio system and/or display, a navigation system and/or display, a climate system and/or display, an electrically powered fan, etc.) The vehicle 10 also includes a speed sensor 20 (e.g., vehicle speed sensor, engine RPM sensor, etc.), an ambient light sensor 22, a driver interface 24 (such as a button, dial, touch screen, etc.), a gear PRNDL 25, and one or more controllers 26.

The controllers 26 may implement/execute the algorithms discussed with reference to FIG. 1. To that end, the controllers 26 may be operatively arranged with the headlights 12, the light source 16, the accessory devices 18, the sensors 20, 22, the interface 24 and the gear PRNDL 25. That is, the controllers 26 may detect whether the headlights 12 are on or off in any suitable/known fashion, and may cause the amount of electrical power supplied to the light source 16 and the accessory devices 18 to be turned on, turned off, or altered in level. The controllers 26 may also receive speed and ambient light information detected by the sensors 20, 22 respectively via any suitable/known vehicle communication network such as a controller area network. The controllers 26 may further receive driver input from the interface 24 selecting a lighting intensity level for the light source 16 (and/or driver input disabling the Auto Dim strategy discussed below), and receive gear PRNDL position information (e.g., “Park,” “Reverse,” Drive,” etc.) via any suitable/known vehicle communication network.

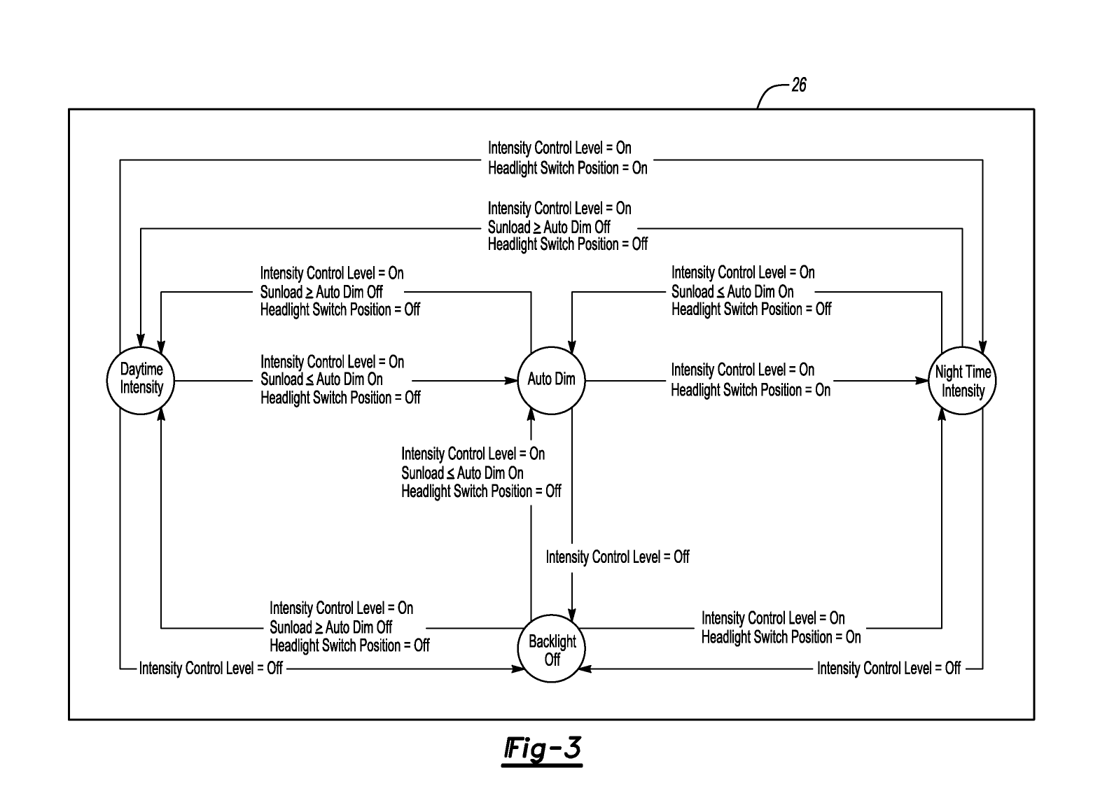

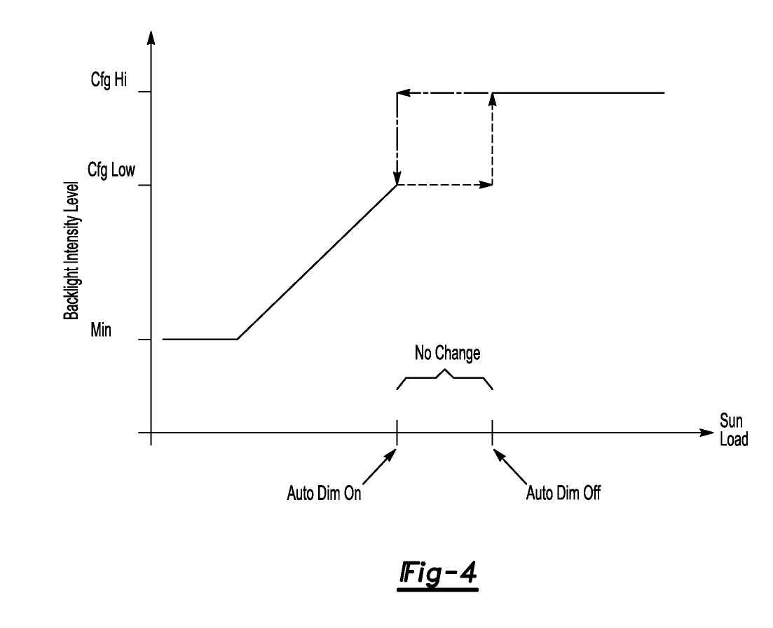

Referring to FIGS. 2 and 3, an embodiment of a control algorithm similar to those discussed with reference to FIG. 1 is illustrated in state transition form. In this embodiment, Daytime Intensity is the intensity of the light source 16 (within a configurable range; for example, between “Cfg Hi” and “Cfg Low” of FIG. 4) when the sun load is greater than or equal to a threshold that can be calibrated for a specific vehicle; Auto Dim is the strategy that automatically ramps down (or in other embodiments, turns off) the light source 16 intensity as a function of sun load data; Nighttime Intensity is the intensity of the light source 16 (within a configurable range) when the headlights 12 are on; and, Backlight Off is the intensity of the light source 16 if the customer turns off the light source 16 (that is, the intensity of the light source 16 is zero).

Referring to FIGS. 2 and 4, an example intensity level for the light source 16 is plotted as a function of sun load. If the sun load (as measured by the sensor 22, for example) is greater than the auto dim off threshold, the intensity of the light source 16 will be at a maximum (unless a driver reduces the intensity via the interface 24). If the sun load is less than the auto dim on threshold, the intensity of the light source 16 will be reduced as a function of the sun load to an eventual minimum. This minimum, in certain embodiments, may result in an off condition for the light source 16.

In the embodiment of FIG. 4, the auto dim on and auto dim off thresholds do not have the same value. This is to avoid frequent (and potentially annoying) changes to backlight intensity due to temporary changes in ambient lighting conditions around the thresholds. (Such thresholds may be determined based on testing, simulation, customer expectations, etc.) During a sunny day when ambient sun load is just greater than the auto dim off threshold for example, ambient light levels may temporarily be less than the auto dim off threshold if a vehicle is driven on streets with sufficiently tall and densely packed buildings. By selecting the auto dim on threshold to have a value that is less than the auto dim off threshold, such temporary (and relatively minor) changes in sun load will not cause a change in backlighting unless the sun load becomes less than the auto dim on threshold. Likewise, at dusk when ambient sun load is just less than the auto dim on threshold for example, ambient light levels may temporarily be greater than the auto dim on threshold if a vehicle is driven on streets with sufficiently bright and densely packed streetlights. Such temporary (and relatively minor) changes in sun load will not cause a change in backlighting unless the sun load becomes greater than the auto dim off threshold.

The thresholds, in other embodiments, may have the same value or a single threshold may be used as design considerations dictate. In these (and other) embodiments, a timing feature may be used to avoid frequent (and potentially annoying) changes to backlight intensity due to temporary changes in ambient lighting conditions around the threshold(s). As an example, the sun load should remain less than (or greater than) the threshold(s) for some predetermined period of time (e.g., 2 minutes) before a change in backlighting is implemented.

Referring to FIGS. 3 and 4, the algorithm will transition from Backlight Off to Daytime Intensity if the intensity control level is on (that is, a driver has not turned off the backlight functionality), the sun load is greater than the auto dim off threshold, and the headlights 12 (FIG. 2) are off. The algorithm will transition from Backlight Off to Auto Dim if the intensity control level is on, the sun load is less than the auto dim on threshold, and the headlights 12 are off. The algorithm will transition from Backlight Off to Nighttime Intensity if the intensity control level is on and the headlights 12 are on.

The algorithm will transition from Daytime Intensity to Nighttime Intensity if the intensity control level is on and the headlights 12 are on. The algorithm will transition from Daytime Intensity to Auto Dim if the intensity control level is on, the sun load is less than the auto dim on threshold, and the headlights 12 are off. The algorithm will transition from Daytime Intensity to Backlight Off if the intensity control level is off (that is, if a driver has turned off the backlight functionality).

The algorithm will transition from Nighttime Intensity to Daytime Intensity if the intensity control level is on, the sun load is greater than the auto dim off threshold, and the headlights 12 are off. The algorithm will transition from Nighttime Intensity to Auto Dim if the intensity control level is on, the sun load is less than the auto dim on threshold, and the headlights 12 are off. The algorithm will transition from Nighttime Intensity to Backlight Off if the intensity control level is off.

The algorithm will transition from Auto Dim to Backlight Off if the intensity control level is off. The algorithm will transition from Auto Dim to Daytime Intensity if the intensity control level is on, the sun load is greater than the auto dim off threshold, and the headlights 12 are off. The algorithm will transition from Auto Dim to Nighttime Intensity if the intensity control level is on and the headlights 12 are on.

Referring again to FIG. 2, the control strategies discussed with reference to FIGS. 3 and 4 may also be applied to the accessory devices 18 as mentioned above. For example, in addition to (or instead of) the controllers 26 altering the amount of electrical power supplied to the light source 16, the controllers 26 may alter the amount of power supplied to the accessory devices 18 as a function of at least some of the inputs described in FIG. 1 in a manner generally consistent with the strategies discussed with reference to FIGS. 3 and 4.

As also mentioned above, other and/or different inputs such as vehicle speed, gear PRNDL position, engine RPM, etc. may be used. As an example, before transitioning from any of Daytime Intensity, Nighttime Intensity or Backlight Off to Auto Dim (FIG. 3), the controllers 26 may additionally determine whether the vehicle speed (or engine RPM) is above some threshold such as 1 MPH (or 500 RPM in the case of engine RPM). If so, it may transition to Auto Dim (if the other applicable conditions are met). If not, it may not transition to Auto Dim. Likewise, the controllers 26 may determine whether the gear PRNDL 25 is in “Drive” before transitioning, etc. Other scenarios are, of course, also possible.

As apparent to those of ordinary skill, the algorithms disclosed herein may be deliverable to a processing device, which may include any existing electronic control unit or dedicated electronic control unit, in many forms including, but not limited to, information permanently stored on non-writable storage media such as ROM devices and information alterably stored on writeable storage media such as floppy disks, magnetic tapes, CDs, RAM devices, and other magnetic and optical media. The algorithms may also be implemented in a software executable object. Alternatively, the algorithms may be embodied in whole or in part using suitable hardware components, such as Application Specific Integrated Circuits (ASICs), state machines, controllers or other hardware components or devices, or a combination of hardware, software and firmware components.

While embodiments of the invention have been illustrated and described, it is not intended that these embodiments illustrate and describe all possible forms of the invention. The words used in the specification are words of description rather than limitation, and it is understood that various changes may be made without departing from the spirit and scope of the invention.

What is claimed:

1. A vehicle comprising:
a headlight;
a sensor configured to detect an ambient light level;
an instrument cluster;
an illumination source having a variable intensity and configured to illuminate the instrument cluster; and
at least one controller configured to detect a headlight condition wherein the headlight is off and the ambient light level is less than a predetermined threshold, and to reduce the illumination source intensity in response to detecting the headlight condition.

2. The vehicle of claim 1 further comprising another sensor configured to detect a speed of the vehicle, wherein the at least one controller is further configured to detect a speed condition wherein the speed of the vehicle is greater than a predetermined speed threshold, and to reduce the illumination source intensity in response to detecting the speed condition.

3. The vehicle of claim 1 wherein the at least one controller is further configured to reduce the illumination source intensity to zero.

4. The vehicle of claim 1 wherein the illumination source intensity is driver selectable.

5. The vehicle of claim 4 wherein the at least one controller is further configured to detect an illumination source condition wherein the illumination source is on, and to reduce the illumination source intensity in response to detecting the illumination source condition.

6. The vehicle of claim 1 wherein the at least one controller is further configured to detect a time period condition wherein the ambient light level is less than the predetermined threshold for at least a predefined minimum period of time, and to reduce the illumination source intensity in response to detecting the time period condition.

7. The vehicle of claim 1 further comprising a gear PRNDL, wherein the at least one controller is further configured to detect a gear PRNDL condition wherein the gear PRNDL is in drive, and to reduce the illumination source intensity in response to detecting the gear PRNDL condition.

8. A method of alerting a driver of a vehicle that a headlight is off comprising:
determining whether the headlight is off;
determining whether an ambient light level is less than a predetermined threshold; and
causing, by a controller, an intensity of an instrument cluster illumination source to be reduced if the headlight is off and the ambient light level is less than the predetermined threshold.

9. The method of claim 8 further comprising determining a speed of the vehicle, wherein the intensity of the illumination source is caused to be reduced if the speed of the vehicle is greater than a predetermined speed threshold.

10. The method of claim 8 wherein the intensity of the illumination source is caused to be reduced to zero.

11. The method of claim 8 further comprising determining whether the illumination source is on, wherein the intensity of the illumination source is caused to be reduced if the illumination source is on.

12. The method of claim 8 further comprising receiving information indicative of an on/off state of the headlight, wherein the determination as to whether the headlight is off is based on the information.

13. The method of claim 8 further comprising receiving information indicative of an ambient light level, wherein the determination as to whether the ambient light level is less than the predetermined threshold is based on the information.

14. The method of claim 8 further comprising determining a period of time during which the ambient light level is less than the predetermined threshold if the ambient light level is less than the predetermined threshold, wherein the intensity of the illumination source is caused to be reduced if the period of time is greater than a predetermined time threshold.

15. A vehicle comprising:
a headlight;
a sensor configured to detect an ambient light level;
an electrically powered vehicle interior accessory device; and
at least one controller configured to detect a headlight condition wherein the headlight is off and the ambient light level is less than a predetermined threshold, and to reduce electrical power supplied to the accessory device in response to detecting the headlight condition to inform a driver that the headlight is off.

16. The vehicle of claim 15 further comprising another sensor configured to detect a speed of the vehicle, wherein the at least one controller is further configured to detect a speed condition wherein the speed of the vehicle exceeds a predefined speed threshold, and to reduce the electrical power supplied to the accessory device in response to detecting the speed condition.

17. The vehicle of claim 15 wherein the at least one controller is further configured to reduce the electrical power supplied to the accessory device such that the accessory device is turned off.

18. The vehicle of claim 15 wherein the accessory device is an interior light, a navigation system display, a radio system display, a climate control system display, or a climate system fan.

19. The vehicle of claim 15 wherein the at least one controller is further configured to detect a time period condition wherein the ambient light level is less than the predetermined threshold for at least a predefined minimum period of time, and to reduce the electrical power supplied to the accessory device in response to detecting the time period condition.
